(19) United States
(12) Patent Application Publication
(10) Pub. No.: US 2004/0139483 A1
(43) Pub. Date: Jul. 15, 2004

(54) System and method for authorizing data broadcasting contents

(76) Inventors: Deok-Jung Kim, Seoul (KR); Sung-Kyu Kim, Seoul (KR); Joon-Sun Ryu, Kyungki-do (KR); Dong-Hwan Min, Seoul (KR); In-Sook Kim, Seoul (KR)

Correspondence Address: Fulbright & Jaworski, Twenty Ninth Floor, 865 South Figueroa, Los Angeles, CA, 90017-2571, US

(21) Appl. No.: 10/469,200

(22) PCT Filed: Feb. 21, 2002
(86) PCT No.: PCT/KR02/00281

(30) Foreign Application Priority Data
Feb. 23, 2001 (KR) 2001-0009299
Dec. 26, 2001 (KR) 2001-0084945

(51) Int. Cl. H04N 7/16; H04N 5/222; H04N 7/173

(52) U.S. Cl. 725/138; 348/722; 725/117; 725/147; 725/135; 725/110; 725/112; 725/115

(57) ABSTRACT

Disclosed is a data broadcasting contents authoring system which comprises: an authoring engine for modifying objects or images to fit to a data broadcasting format, and authoring new data broadcasting contents; a data converter for receiving the data broadcasting contents authored by the authoring engine, and converting the contents into a standard file format to fit to at least one data broadcasting standard; and a code generator for receiving the generated contents data from the authoring engine, and the converted contents data from the data converter, and converting them into a broadcasting contents format that fits at least one broadcasting standard. As described above, the present invention enables users to easily and quickly author desired data broadcasting contents using a WYSIWYG broadcasting contents development tool.

### BACKGROUND OF THE INVENTION

(a) Field of the Invention

The present invention relates to data broadcasting. More specifically, the present invention relates to a system and method for authoring data broadcasting contents so that any user who is not an expert may easily author data broadcasting contents.

(b) Description of the Related Art

In general, as shown in FIG. 1, data broadcasting enables provision of broadcasts, broadcast-related information, weather, stocks, and news through broadcasting networks, and information through the Internet, and execution of electronic commerce (EC) through the Internet. Data broadcasting functions as a new information infrastructure for general users, and creates new related industries having highly added values such as services, devices, and contents.

In order to activate data broadcasting, abundant and various quality contents are essential, and for this, it is absolutely required to develop an authoring system for easily producing data broadcasting contents, and effectively managing and controlling them. Also, in order to produce the data broadcasting contents, planners, writers, producers, computer graphic designers, and language programmers are needed.

However, in the case of authoring data broadcasting contents by linking computer graphics to programs such as HTML/XHTML/JavaScript, and Java, since the features of editing HTML under the web environment are different from those of the data broadcasting contents, it is difficult to author the actual data broadcasting contents using a data broadcasting contents development tool.

Also, since an author authors desired data broadcasting contents using the software development kit (SDK), it is impossible to author the data broadcasting contents when the author is not an expert in using the SDK.

### SUMMARY OF THE INVENTION

It is an object of the present invention to enable a user to easily author data broadcasting contents.

It is another object of the present invention to modify the interface of a data broadcasting contents development tool to be similar to the interface of an authoring tool skillfully used by a computer graphic designer, and automatically generate job results in a web-environment program code format.

It is still another object of the present invention to display contents cooperatively produced by a plurality of users in a shared program display format, and to maintain the quality of products at a predetermined level.

It is still another object of the present invention to enable a layman to easily author digital broadcasting contents using a WYSIWYG (what you see is what you get) type contents development tool.

In one aspect of the present invention, a data broadcasting contents authoring system comprises: an authoring engine for modifying objects or images to fit a data broadcasting format, and authoring new data broadcasting contents; a data converter for receiving the data broadcasting contents authored by the authoring engine, and converting the contents into a standard file format to fit at least one data broadcasting standard; and a code generator for receiving the generated contents data from the authoring engine, and the converted contents data from the data converter, and converting them into a broadcasting contents format that fits at least one broadcasting standard.

In another aspect of the present invention, in a contents authoring method using a data broadcasting contents authoring system, a data broadcasting contents authoring method comprises: receiving additional items at a new contents page to complete a default screen configuration, and setting links between pages to link the new contents page including at least one page, and thereby setting a default page; converting the contents into a broadcasting contents format that fits to a standard file format and at least one broadcasting standard so that the contents may satisfy at least one data broadcasting standard on the basis of the newly authored data broadcasting contents, and authoring new data broadcasting contents; and mixing the authored data broadcasting contents with externally provided audio and video data, and displaying them to be checked by a user on the screen.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a conventional data broadcasting infrastructure;

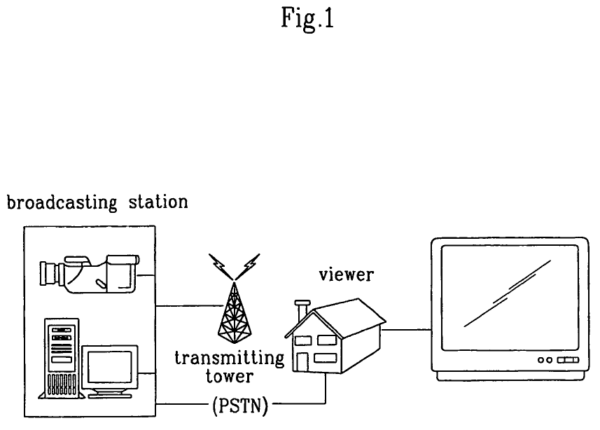

FIG. 2 shows a block diagram of a data broadcasting contents authoring system according to a preferred embodiment of the present invention; and

FIG. 3 shows a flowchart of a data broadcasting contents authoring method according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

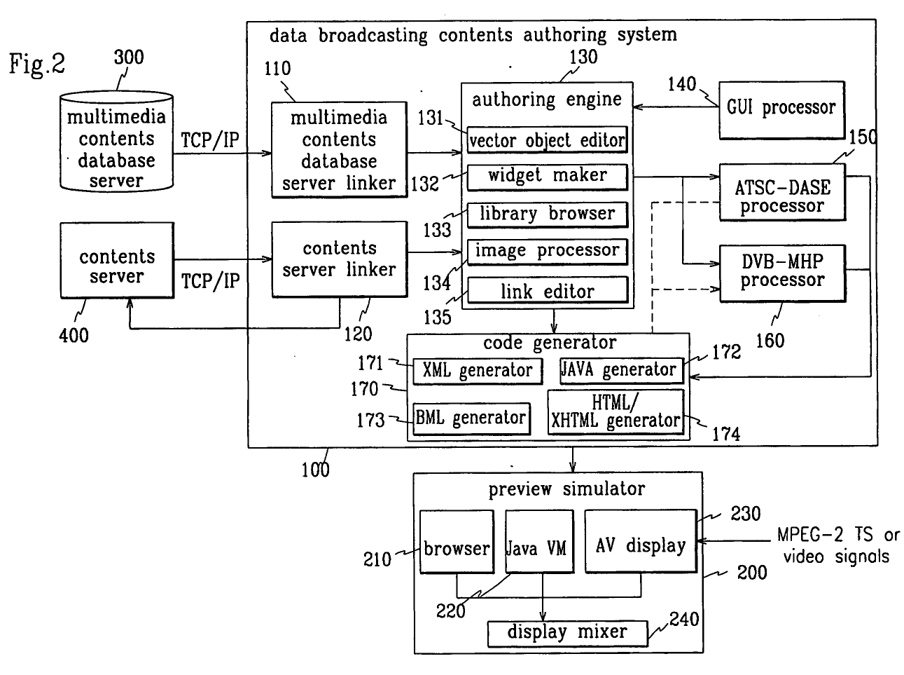

FIG. 2 shows a block diagram of a data broadcasting contents authoring system according to a preferred embodiment of the present invention.

As shown, the data broadcasting contents authoring system comprises: a data broadcasting contents authoring unit 100 for calling contents to a multimedia contents database server 300 of a broadcasting station that stores data broadcasting contents, through a network, receiving contents for authoring the broadcasting contents from a contents server 400, and authoring data broadcasting contents; and a preview simulator 200 for previewing authored contents.

The data broadcasting contents authoring unit 100 comprises: a multimedia contents database server linker 110; a contents server linker 120; an authoring engine 130; a graphic user interface (GUI) processor 140; an ATSC-DASE (advanced television systems committee—digital TV application software environment: US digital broadcasting standard) processor 150; a DVB-MHP (digital video broadcasting—multimedia home platform: Europe digital broadcasting standard) processor 160; and a code generator 170.

The multimedia contents database server linker 110 maintains connection with the multimedia contents database server 300 that stores audio, video, and image clips built in the conventional broadcasting station through a network, and calls basic contents for authoring data broadcasting contents.

The contents server linker 120 is connected to the multimedia contents database server 300 that stores contents data previously made by the authoring engine 130, through a network, and supports calling of the data broadcasting contents from the contents server 400.

The authoring engine is a tool with which a user can easily author the data broadcasting contents, and it is used to author new data broadcasting contents using the contents data called by the multimedia contents database server linker 110 or the contents server linker 120.

The GUI 140 processor processes respective events input by a user's input device and displays them so that the user (or a contents author) may easily author desired data broadcasting contents.

The ATSC-DASE processor 150 receives data broadcasting contents generated by the authoring engine 130, refers to objects and actions composed by the user through the application program interface (API) that fits the ATSC standard specification, and converts the data broadcasting contents into a standard file format with the ATSC-DASE.

The DVB-MHP processor 160 receives the contents authored by the user from the authoring engine 130, and converts the contents into a standard file format with the DVB-MHP.

The code generator 170 comprises an XML (extensive markup language) generator 171 for generating source codes of a corresponding program language; a Java generator 172; a BML (broadcasting markup language) generator 173; and an HTML/XHTML (extensible hypertext markup language) generator 174, and it converts the contents generated by the user into general data broadcasting contents through a previously defined conversion algorithm. Since each object of the authoring engine 130 has a protocol to be converted into a broadcasting standard, the code generator 170 refers to this protocol and converts the contents into a general data broadcasting contents format.

The above-described function units may be programs or devices that store the programs, each of which individually performs its function, and the function units may be a single program with integrated functions or a device that stores the single program, and the present invention is not restricted to the preferred embodiment of the present invention.

The authoring engine 130 comprises a vector object editor 131; a widget maker 132; a library browser 133; an image processor 134; and a link editor 135.

The vector object editor 131 processes tasks for generating, editing, and deleting default objects used for generating source data. In this instance, when the vector object editor 131 uses attributes essential to the objects and generates default objects, all objects inherit the attributes of the default objects. The above-noted objects have their unique attributes in addition to default attributes, and they process the events input by an input device.

The widget maker 132 generates reusable widgets. In this instance, the widget represents a GUI component for generating templates used for specific tasks so that the user may conveniently handle repeated tasks.

The library browser 133 enables the user to more easily use the contents libraries and widgets. The libraries are stored in a predetermined directory of a specific computer, and the library browser 133 reads and analyzes the contents in a corresponding folder, stores them as a thumbnail image format, and displays them so that the user may conveniently select and use them, and also provides a user interface (UI) so that the user may easily arrange the contents additionally provided to the libraries.

The image processor 134 processes the images to be transparent or semi-transparent, converts the images into various kinds of image formats, and uses a palette and the dithering technique to generate optimized images.

The link editor 135 links contents pages and enables the user to easily add, edit, and delete links by simply using a mouse drag-and-drop function so that the user may conveniently navigate new contents pages.

The preview simulator 200 comprises: a browser 210 for receiving converted contents data from the code generator 170, and checking the pages including completed data broadcasting contents; a Java VM (virtual machine) 230 for receiving Java contents data from the code generator 170 and supporting them to be executed under various kinds of platforms (or, computers or operating systems (O/S) under different environments); an AV (audio/video) display 220 for receiving external MPEG-2 TS (transport streams) or video input signals, and displaying them on a screen; and a display mixer 240 for mixing data display screens displayed by the browser 210 and the Java VM 230 according to their respective data formats with audio and video signals displayed by the AV display 220, and displaying them in a single screen.

The above-described function units of the authoring engine 130 and the respective units of the preview simulator 200 may be programs or devices that store the programs, each of which individually performs its function, and the function units may be a single program with integrated functions or a device that stores the single program, and the present invention is not restricted to the preferred embodiment of the present invention.

Below, an operation of the data broadcasting contents authoring system according to the preferred embodiment of the present invention will be described.

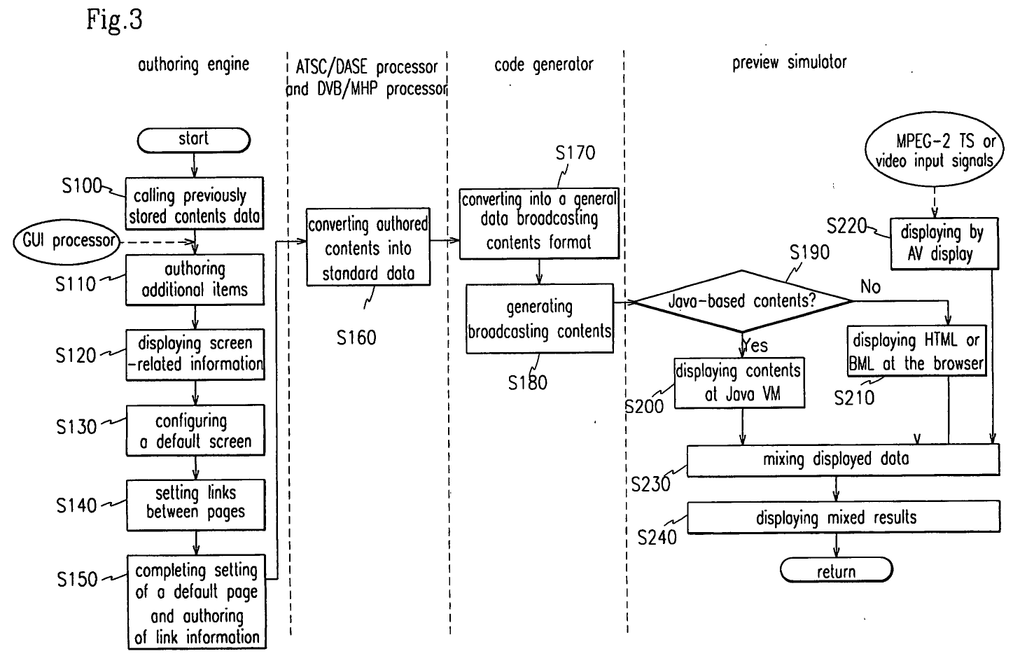

FIG. 3 shows a flowchart of a data broadcasting contents authoring method according to a preferred embodiment of the present invention.

The multimedia contents database server 300 stores audio/video data and files, image files, and sound clips built in the conventional broadcasting stations. The contents server 400 stores the contents data previously made by the authoring engine 130. When a user (or a contents author) drives the authoring engine 130 to configure new data broadcasting contents authoring pages, the authoring engine 130 calls the previously stored contents data through the multimedia contents database server linker 110 and the contents server linker 120 in step S100. In this instance, the contents extracted from the multimedia contents database server 300 and the contents server 400 are converted into default objects through the GUI processor 140, and newly authored contents are also default objects. The source contents represent a bundle of the default objects, and it is not necessary to convert the default objects into source contents.

The user directly authors additional items to be added to new contents authoring pages through the authoring engine 130 on the basis of the called multimedia contents data in step S110. The GUI processor 140 displays screen-related information including the contents in step S120, processes the respective events by an input device (not illustrated), and displays them on the screen.

The user uses the vector object editor 131, the widget maker 132, the library browser 133, and the image processor 134 to complete a default screen configuration in step S130. In this instance, the vector object editor 131 generates, edits, or deletes default objects for generating the source data, which is a very basic task for generating the source data. When the vector object editor uses the attributes required for the objects and generates default objects, all objects inherit the attributes of the default objects.

Since the library is stored in a predetermined directory of a specific computer, the library browser 133 reads the folder's contents, analyzes them, stores them in the thumbnail image format, and displays them so that the user may easily select and use them, and further provides a user interface (UI) so that the user may conveniently arrange the contents added to the library. Also, the library browser 133 enables the user to more easily use the library and widgets of the contents authored by the user.

The widget maker 132 generates reusable widgets. In this instance, the widget represents a GUI component for generating templates used for specific tasks so that the user may conveniently handle repeated tasks.

The widget maker 132 processes the tasks for generating the reusable widgets, that is, it generates horizontal/vertical menus, contents boxes, rollover buttons, and TV frames. A menu widget receives default values on respective ‘normal’, ‘over’, and ‘down’ states from a user, and automatically generates a menu according to a menu configuration. A menu widget for navigation of general pages is most commonly used for the data broadcasting, it has a root menu of a default page, and it generates links for moving from the root menu to other pages. When the user designates menu items, the menu widget automatically generates a plurality of pages referring to the image-type attributes of a previously defined menu. When magnifying or reducing an image, the contents box sets points that will be repeated, so that a more intelligent image magnification function may be used. When the user selects an interval that is repeated and a portion that is uniformly constant on an image, the contents box uses the attributes (repetition/non-repetition) of each portion to execute intelligent image magnification/reduction. The rollover button automatically generates a button for performing different operations according to the present contents' normal/over/down states. The image processor 134 receives data from the vector object editor 131 and the widget maker 132, processes the images to be transparent or semi-transparent, converts the images into various kinds of image formats, and uses a palette and the dithering technique to generate optimized images.

The link editor 135 receives data from the vector object editor 131, the widget maker 132, and the library browser 133, and establishes links between pages so as to link new contents pages including a plurality of pages in step S140.

The link editor 135 supports the user to add, edit, and delete desired pages through the user's manipulation of the mouse, and accordingly, the user can easily navigate desired pages. When the setting of links between the pages is completed, the user completes setting of default pages and authoring of link information through the authoring engine 130 in step S150.

In the preferred embodiment, the contents can be generated through the WYSIWYG method. In this instance, the WYSIWYG method represents an interface or a contents development tool for producing GUI or text pages, and it enables the user to preview result contents on the screen while authoring the contents.

The ATSC-DASE processor 150 and the DVB-MHP processor 160 receive authored contents from the widget maker 132 and the image processor 134, and convert them into respective standard data in step S160. That is, the ATSC-DASE processor 150 refers to the objects and the actions made by the user through the API that corresponds to the ATSC standard specification, converts the contents into the ATSC-DASE standard file format, and the DVB-MHP processor 160 converts the contents into the DVB-MHP standard file format. In addition to the preferred embodiment of the present invention, the data broadcasting contents authoring system can convert them into a standard file format through a specific standard data converter of digital broadcasting, which is not restricted to the preferred embodiment of the present invention.

The code generator 170 receives converted standard file format contents from the ATSC-DASE processor 150 or the DVB-MHP processor 160, receives link information from the link editor 135 of the authoring engine 130, converts them into a general data broadcasting contents format through the XML generator 171, the Java generator 172, the BML generator 173, and the HTML/XHTML generator 174 in step S170, and generates new broadcasting contents in step S180.

The preview simulator 200 receives newly generated data broadcasting contents from the code generator 170, and checks whether the broadcasting contents are generated on the Java basis in step S190. If they are generated on the Java basis, the Java VM displays the generated data broadcasting contents on the screen in step S200. If they are not generated on the Java basis, the browser 210 displays the XHTML, HTML, XML, and BML in step S210. The AV display 230 receives MPEG-2 TS or video input signals from an external device, and displays them on the screen in step S220.

The preview simulator 200 represents an application program stored in a computer or a terminal, and processes functions of a set-top box and a television to display them on the screen. The set-top box receives AV signals and data from broadcasting stations, displays the AV signals on the screen as they are, and displays the data on the screen according to a receiving data format. When the received data are those of XHTML, HTML, and BML, the preview simulator 200 operates the browser 210 and displays the data through browsers of respective formats, and in the case of the DVB-MHP, the preview simulator 200 operates the Java VM 220 and displays the Java contents on the screen. When displaying the AV data of the preview simulator 200, the video data are displayed on the screen using a general TV card, and MPEG-2 TS files are displayed on the screen. In this instance, the television only displays the AV data and the contents on the screen. Accordingly, the preview simulator 200 displays contents on the screen through the browser 210 and the Java VM 220 according to the respective data formats. Here, the browser 210 and the Java VM 220 are used for displaying the contents on the screen.

The display mixer 240 receives data to be displayed from the browser 210, the Java VM 220, and the AV display 230, combines (or mixes) them in step S230, arranges audio and video data on the bottom portion of the screen, and contents data on the top portion of the screen to mix them as if they are a single picture. The display mixer 240 displays mixed results on the screen in step S240.

As described above, the data broadcasting contents authoring system and method enables the users to easily and quickly author the data broadcasting contents using a WYSIWYG broadcasting contents development tool even though the users are not expert.

Also, the interface of the data broadcasting contents development tool is similarly adjusted to that of a development tool fluently used by a computer graphic designer, and task results are automatically authored into web environmental program codes.

Further, the present invention displays the contents cooperated by many users in a unified program format, and maintains the quality of the results at a predetermined level.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A data broadcasting contents authoring system comprising:
an authoring engine for modifying objects or images to fit to a data broadcasting format, and authoring new data broadcasting contents;
a data converter for receiving the data broadcasting contents authored by the authoring engine, and converting the contents into a standard file format to fit at least one data broadcasting standard; and
a code generator for receiving the generated contents data from the authoring engine, and the converted contents data from the data converter, and converting them into a broadcasting contents format that fits at least one broadcasting standard.

2. The system of claim 1, further comprising a display processor for mixing generation contents data of the contents format converted by the code generator with externally provided audio and video data, and performing data processing on them in order for a user to check them on a screen.

3. The system of claim 1, further comprising:
a multimedia contents database server linker for maintaining connection with a multimedia contents database server for storing audio, video, and image clip data through a network, and calling basic contents for authoring data broadcasting contents;
a contents server linker connected to a contents server for storing contents data previously authored by the authoring engine through the network, and for calling the data broadcasting contents from the contents server; and
a graphic user interface (GUI) processor for processing respective events input by the user's input device, and displaying them on the screen.

4. The system of claim 1, wherein the authoring engine comprises:
a vector object editor for processing tasks for generating, editing, or deleting default objects for authoring source data according to events selected by the user;
a widget maker for making a portion of the data broadcasting contents or images into a library, and making a reusable widget;
a library browser for reading contents of a library stored in a predetermined directory, analyzing them, storing them in a thumbnail image format, and displaying them for the user to conveniently select and use them so that the library and widget made by the user may be more easily used;
an image processor for processing the images to be transparent or semi-transparent, and generating images in at least one image file format; and
a link editor for supporting the user to easily add, edit, or delete links between pages so that the user may conveniently navigate contents pages including at least one page.

5. The system of claim 1, wherein the data converter comprises:
an ATSC-DASE (advanced television systems committee—digital TV application software environment) processor for receiving the data broadcasting contents authored by the authoring engine, referring to the objects and actions made by the user through the API (application program interface) corresponding to the ATSC standard specification, and converting the contents into the ATSC-DASE standard file format; and
a DVB-MHP (digital video broadcasting—multimedia home platform) processor for receiving the contents authored by the user from the authoring engine, and converting them into the DVB-MHP standard file format.

6. The system of claim 1, wherein the code generator further comprises at least one program language generator for generating source codes of a corresponding program language, and the code generator refers to a protocol to be converted into a broadcasting standard held by each object of the authoring engine, and converts the contents authored by the user into a general data broadcasting contents format through a previously defined conversion algorithm.

7. The system of claim 2, wherein the display processor comprises:
a browser for receiving the converted contents data from the code generator, and enabling checking of the page that includes the completed data broadcasting contents;
a Java VM (virtual machine) for receiving contents data authored in Java from the code generator, and supporting them to be operated on at least one platform;
an AV (audio and video) display for receiving MPEG-2 TS (transport streams) or video input signals from the outside, and displaying them on the screen; and
a display mixer for mixing data display screens displayed according to respective data formats from the browser and the Java VM with the audio and video signals displayed by the AV display, and displaying them on a single screen.

8. In a contents authoring method using a data broadcasting contents authoring system, a data broadcasting contents authoring method comprising:
receiving additional items at a new contents page to complete a default screen configuration, and setting links between pages to link the new contents page including at least one page, and thereby setting a default page;
converting the contents into a broadcasting contents format that fits to a standard file format and at least one broadcasting standard so that the contents may satisfy at least one data broadcasting standard on the basis of the newly authored data broadcasting contents, and authoring other new data broadcasting contents; and
mixing the authored data broadcasting contents with externally provided audio and video data, and displaying them to be checked by a user on the screen.

9. The method of claim 8, wherein the step of setting a default page comprises:
calling contents data from an information storage device that stores previously authored contents data, and authoring additional items to be added to the new contents authoring page;
processing a default screen configuration through an authoring engine, and setting links between pages so as to link new contents pages including at least one page; and
completing setting of a default page of the new contents and authoring of link information.

10. The method of claim 9, wherein the step of authoring additional items comprises:
processing tasks of generating, editing, or deleting default objects for generating source data;
reading folder contents, analyzing them, storing them in a thumbnail image format, and displaying them on the screen so that the user may easily select and use them; and
generating a reusable widget.

11. The method of claim 10, wherein in the step of generating a reusable widget, a menu widget for receiving default values of at least one screen display state from the user and automatically generating a menu, a contents box for setting points to be repeated, using attributes of respective portions of an image, and magnifying or reducing the image, and a rollover button for automatically generating a button that is differently operated according to states of the current contents.

12. The method of claim 8, wherein the step of authoring other data broadcasting contents comprises:
receiving authored contents and converting them into at least one broadcasting standard data; and
receiving the contents of the converted standard file format, receiving link information on at least one of the contents, converting them into a general data broadcasting contents format, and generating new broadcasting contents.

13. The method of claim 8, wherein the step of displaying comprises:
receiving newly generated data broadcasting contents, checking whether the generated broadcasting contents are authored using a first programming language, and when they are authored using the first programming language, displaying the generated data broadcasting contents through a virtual machine that supports the contents data authored using the first programming language to be implemented on at least one different platform;
displaying the authored contents on the screen through a corresponding browser when the contents are authored using a specific programming language and not the first programming language;
receiving MPEG-2 TS (transport streams) or video input signals from an external device and displaying them on the screen; and
mixing the contents data authored using the first program language or the specific program language with the MPEG-2 TS or video input signals, and displaying mixed results on the screen.
